(19) United States
(12) Patent Application Publication
(10) Pub. No.: US 2014/0304631 A1
(43) Pub. Date: Oct. 9, 2014

(54) METHOD AND DEVICE FOR ARRANGING ICONS

(71) Applicant: Xiaomi Inc., Beijing (CN)

(72) Inventors: Ying WANG, Beijing (CN); Daqing Sun, Beijing (CN); Fei Xu, Beijing (CN); Weixing Li, Beijing (CN)

(73) Assignee: Xiaomi Inc., Beijing (CN)

(21) Appl. No.: 14/166,134

(22) Filed: Jan. 28, 2014

Related U.S. Application Data
(63) Continuation of application No. PCT/CN2013/085872, filed on Oct. 24, 2013.

(30) Foreign Application Priority Data
Apr. 8, 2013 (CN) 201310120284.3

(51) Int. Cl. G06F 3/0481; G06F 3/0482

(52) U.S. Cl. CPC G06F 3/04817; G06F 3/0482
USPC 715/765

(57) ABSTRACT

A method for a device to arrange icons displayed on a screen of the device includes creating a buffer region in a memory of the device; marking one or more icons selected by a user as one or more icons to be arranged; storing the icons to be arranged in the buffer region; and performing an arranging operation on the icons to be arranged that are stored in the buffer region, according to an arranging instruction from the user.

### CROSS REFERENCE TO RELATED APPLICATIONS

This application is a continuation of International Application No. PCT/CN2013/085872, filed Oct. 24, 2013, which is based upon and claims priority to Chinese Patent Application No. 201310120284.3, filed Apr. 8, 2013, the entire contents of all of which are incorporated herein by reference.

### TECHNICAL FIELD

The present disclosure generally relates to the field of mobile terminals and, more particularly, to a method and a device for arranging icons.

### BACKGROUND

With development of mobile terminals, various applications (APPs), such as office APPs, game APPs, photo APPs and the like, are provided for being installed on the mobile terminals to perform various functions. After an APP is installed on a mobile terminal, an icon is generated and displayed on a desktop of the mobile terminal for being clicked by a user to start the APP. When the user installs a great number of APPs on the mobile terminal, there are a great number of icons generated and displayed on the desktop.

The mobile terminal generally can arrange icons on the desktop based on a user operation, such as an operation for moving an icon or an operation for deleting an icon. Conventionally, however, the mobile terminal can arrange one icon based on each operation, which may be time-consuming when the mobile terminal receives user operations to arrange multiple icons on the desktop.

### SUMMARY

According to a first aspect of the present disclosure, there is provided a method for a device to arrange icons displayed on a screen of the device, comprising: creating a buffer region in a memory of the device; marking one or more icons selected by a user as one or more icons to be arranged; storing the icons to be arranged in the buffer region; and performing an arranging operation on the icons to be arranged that are stored in the buffer region, according to an arranging instruction from the user.

According to a second aspect of the present disclosure, there is provided a device, comprising: a processor; a memory for storing instructions executable by the processor; and a screen; wherein the processor is configured to: create a buffer region in the memory; mark one or more icons selected by a user as one or more icons to be arranged; store the icons to be arranged in the buffer region; and perform an arranging operation on the icons to be arranged that are stored in the buffer region, according to an arranging instruction from the user.

According to a third aspect of the present disclosure, there is provided a non-transitory computer-readable medium having stored therein instructions that, when executed by a processor of a device, cause the device to perform a method for arranging icons displayed on a screen of the device, the method comprising: creating a buffer region in a memory of the device; marking one or more icons selected by a user as one or more icons to be arranged; storing the icons to be arranged in the buffer region; and performing an arranging operation on the icons to be arranged that are stored in the buffer region, according to an arranging instruction from the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for a device to arrange icons, according to an exemplary embodiment.

FIG. 2 is a flowchart of a method for a device to arrange icons, according to an exemplary embodiment.

FIG. 3 is a diagram of a display on a screen of a device, according to an exemplary embodiment.

FIG. 4 is a diagram showing that a batch arranging mode is triggered, according to an exemplary embodiment.

FIG. 5 is a diagram of a display on the screen of the device, according to an exemplary embodiment.

FIG. 6 is a diagram showing that the device receives user selection of an icon, according to an exemplary embodiment.

FIG. 7 is a diagram showing that icons of n applications are selected, respectively, according to an exemplary embodiment.

FIG. 8 is a diagram showing that the device detects a click on a blank area to close a folder in a batch arranging mode, according to an exemplary embodiment.

FIG. 9 is a diagram showing that a single icon is moved from a first predetermined area to an empty space on a desktop, according to an exemplary embodiment.

FIG. 10 is a diagram showing that the device receives a long press on an icon to be arranged, according to an exemplary embodiment.

FIG. 11 is a diagram showing that the device detects a two-finger pinch on icons in a first predetermined area, according to an exemplary embodiment.

FIG. 12 is a diagram of a display on the screen of the device, according to an exemplary embodiment.

FIG. 13 is a diagram showing that the device receives a click on target icons to be moved, according to an exemplary embodiment.

FIG. 14 is a diagram of a display on the screen of the device, according to an exemplary embodiment.

FIG. 15 is a diagram of a display on the screen of the device, according to an exemplary embodiment.

FIG. 16 is a diagram showing that the device receives a long press on target icons, according to an exemplary embodiment.

FIG. 17 is a diagram showing that the device places target icons onto a desktop, according to an exemplary embodiment.

FIG. 18 is a diagram showing that a target icon is dragged to an area occupied by an icon, according to an exemplary embodiment.

FIG. 19 is a diagram of a display on the screen of the device, according to an exemplary embodiment.

FIG. 20 is a diagram showing that a target icon is dragged to a removing bar, according to an exemplary embodiment.

FIG. 21 is a diagram of a display on the screen of the device, according to an exemplary embodiment.

FIG. 22 is a diagram showing that the device detects a click on a widget icon in a batch arranging mode, according to an exemplary embodiment.

FIG. 23 is a block diagram of a device for arranging icons, according to an exemplary embodiment.

FIG. 24 is a block diagram of a device for arranging icons, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

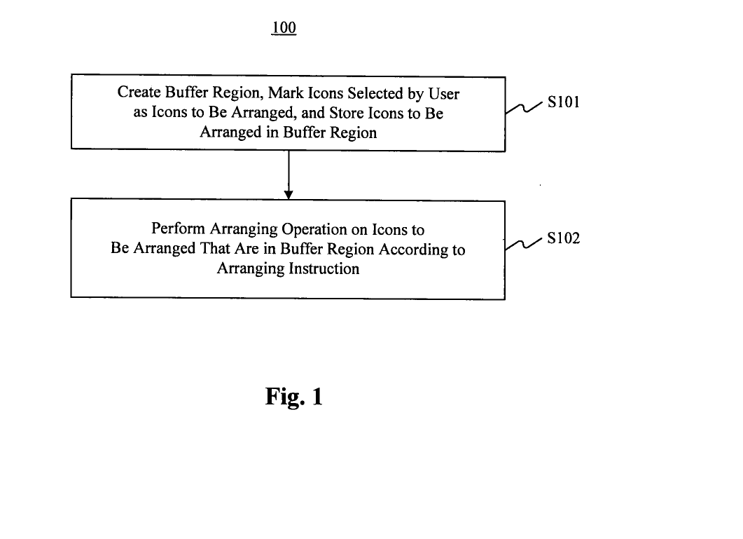

FIG. 1 is a flowchart of a method 100 for a device to arrange icons, according to an exemplary embodiment. For example, the device displays on its screen a desktop including a plurality of icons. Each of the icons may be an application (APP) icon representing an application or a folder icon representing a folder. Referring to FIG. 1, the method 100 includes the following steps.

In step S101, the device creates a buffer region in its memory, marks one or more icons selected by the user as icons to be arranged, and stores the icons to be arranged in the buffer region.

In one exemplary embodiment, before creating the buffer region, the desktop of the device enters an edit mode based on a user operation, and the device sets a first predetermined area on the screen as a widget selecting area for selection by the user. When the device detects that any icon on the desktop is clicked, the device creates the buffer region and sets the first predetermined area on the screen as a display area for the icons to be arranged, and displays in the first predetermined area the icons to be arranged.

In one exemplary embodiment, the device marks the icons selected by the user as the icons to be arranged and stores in the buffer region, according to a sequence that the icons are selected by the user, and also displays the icons in the first predetermined area according to the sequence that the icons are selected by the user.

In one exemplary embodiment, an icon selected by the user is a folder icon representing a folder. Accordingly, the device opens the folder by displaying all icons in the folder, and marks at least one icon in the folder as an icon to be arranged based on a user selection. The device further closes the folder if the device detects a click on any area in the display area of the folder other than the display area of all the icons in the folder and a title of the folder.

Still referring to FIG. 1, in step S102, the device performs an arranging operation on the icons to be arranged that are in the buffer region, according to an arranging instruction received from the user. The device may further remove the icons to be arranged from the buffer region after performing the arranging operation.

In one exemplary embodiment, the device detects a click on an icon to be arranged that is displayed in the first predetermined area. Accordingly, the device places the clicked icon as a target icon onto a first empty space on the desktop.

In one exemplary embodiment, the device detects a press longer than a first preset time period on an icon to be arranged that is displayed in the first predetermined area. Accordingly, the device sets the icon as the target icon, and sets a second predetermined area on the screen as a display area for a removing bar. Further, if the device detects that the target icon is dragged to the second predetermined area, the device removes the target icon and uninstalls an APP corresponding to the target icon; if the device detects that the target icon is dragged to a location on the desktop without an icon, the device places the target icon at the location, e.g., through pushing away other icons adjacent to the location and inserting the target icon; and if the device detects that the target icon is dragged to a region occupied by an icon on the desktop, the devices generates a folder with a preset name in the region, and places the icon occupying the region and the target icon into the generated folder.

In one exemplary embodiment, if the device detects that a preset event is triggered, the device displays a number of all the icons to be arranged stored in the buffer region, and sets all the icons to be arranged as target icons. For example, the preset event may be an event that two contacts on the screen move toward each other in the first predetermined area, such as a two-finger pinch event, or an event that a single contact moves in one direction in the first predetermined area, such as a one-finger sliding event.

In one exemplary embodiment, if the device detects a click on the target icons, the device places the target icons onto empty spaces on the desktop according to a sequence that the target icons are selected by the user. In one exemplary embodiment, if the device detects a press longer than a second preset time period on the target icons, the device sets the second preset area as the display area of the removing bar. Further, if the device detects that the target icons are dragged to the second predetermined area, the device removes the target icons and uninstalls respective APPs corresponding to the target icons; if the device detects that the target icons are dragged to a region occupied by an icon on the desktop, the device generates a folder with a preset name at the region, and places the icon occupying the region and the target icons into generated the folder; if the device detects that the target icons are dragged to a location on the desktop without an icon, e.g., an empty space between two icons on the desktop, the device places the target icon at the location directly, or through pushing the two icons adjacent to the location and inserting the target icons.

In one exemplary embodiment, to place the target icons onto the empty spaces on the desktop according to the sequence that the icons are selected by the user, the device determines whether there are sufficient empty spaces on the desktop. If the device determines that there are sufficient empty spaces on the desktop, the device places the target icons onto the empty spaces on the desktop according to the sequence that the icons are selected by the user. If the device determines that there are not sufficient empty spaces on the desktop, the device determines the icons to be placed according to a number of the empty spaces and the sequence that the icons are selected by the user, and places the determined icons onto the empty spaces according to the sequence that the icons are selected by the user.

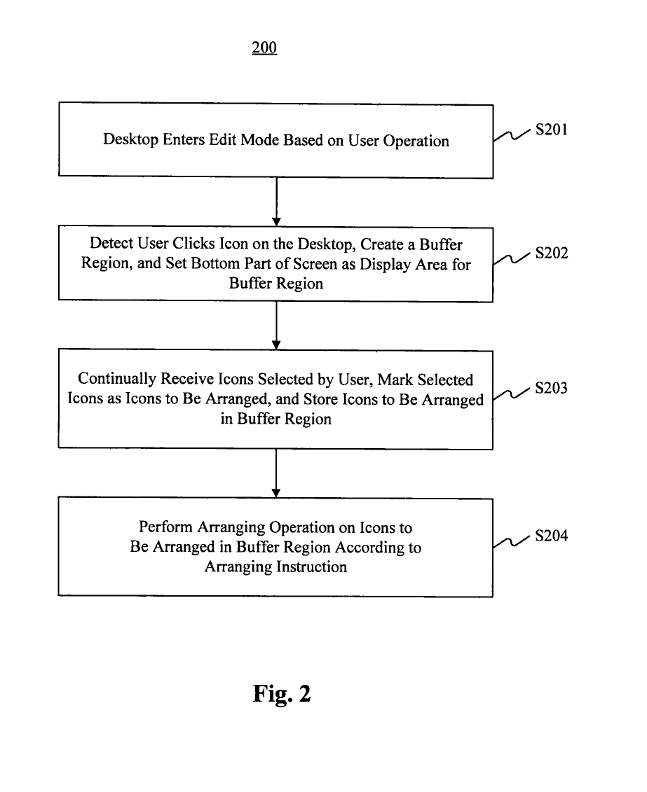

FIG. 2 is a flowchart of a method 200 for a device to arrange icons, according to an exemplary embodiment. For example, the device displays on its screen a desktop including a plurality of icons. Referring to FIG. 2, the method 200 includes the following steps.

In step S201 the desktop of the device enters an edit mode based on a user operation. For example, the user may perform a two-finger pinch on the display for the desktop to enter the edit mode. Also for example, entering the edit mode may be triggered by a preset event, such as a long press on a blank area on the desktop or a selection of a menu option to enter the edit mode.

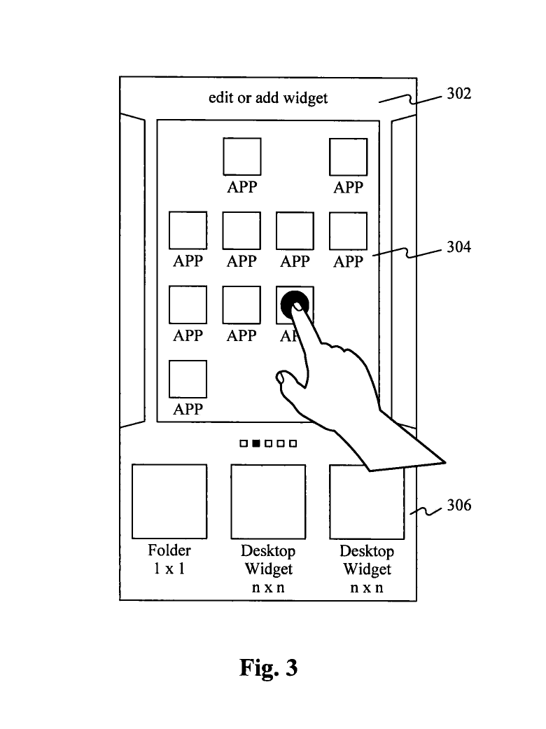

After the desktop enters the edit mode, the device can receive user input to arrange icons on the desktop. FIG. 3 is a diagram of a display on the screen of the device when the desktop is in the edit mode, according to an exemplary embodiment. Referring to FIG. 3, a top part 302 of the screen corresponds to the above described second predetermined area, which is a text prompt area/removing area, a middle part 304 of the screen displays a thumbnail of the desktop including APP icons to be arranged by the user, and a bottom part 306 of the screen corresponds to the above described first predetermined area, which can display, e.g., thumbnails of folders, plug-ins or desktop widgets to be selected by the user.

Referring to FIGS. 2 and 3, in step S202, the device detects that the user clicks an icon on the desktop, creates a buffer region, and sets the bottom part 306 of the screen as a display area for the buffer region. The buffer region is a portion of the memory of the device for storing one or more icons to be arranged, and for facilitating a batch process for the icons. When the device creates the buffer region, the device enters a batch arranging mode. In the illustrated embodiment, the icon being clicked by the user is considered a triggering condition of the batch arranging mode.

In exemplary embodiments, after the batch arranging mode is triggered, the first predetermined area is also the display area of the buffer region. The device displays the icons to be arranged that are stored in the buffer region on the display area, and removes the same icons from the thumbnail of the desktop.

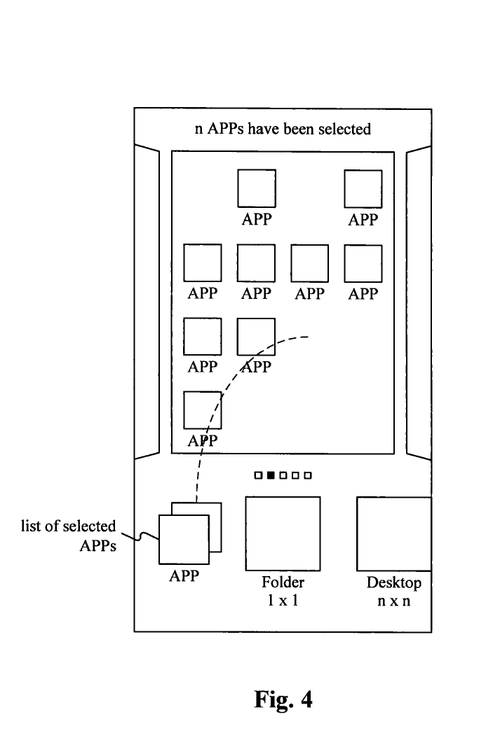

FIG. 4 is a diagram showing that the batch arranging mode is triggered for the device, according to an exemplary embodiment. Referring to FIG. 4, the first predetermined area displays a list of selected APPs. In the illustrated embodiment, to improve user experience, the device displays an animation showing that an icon selected by the user falls into the first predetermined area, represented by the dotted line in FIG. 4.

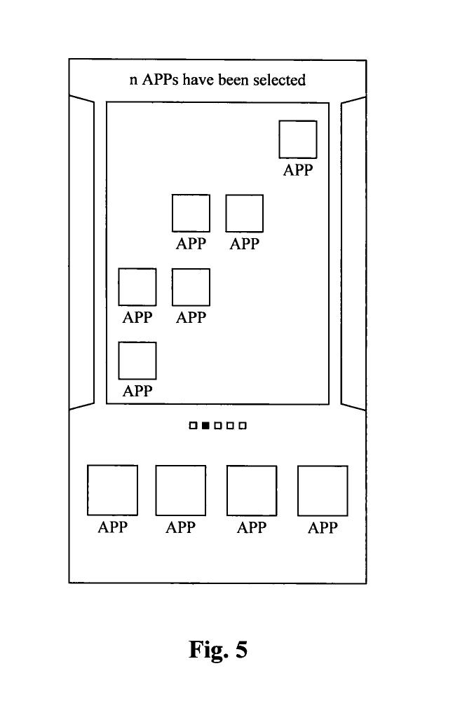

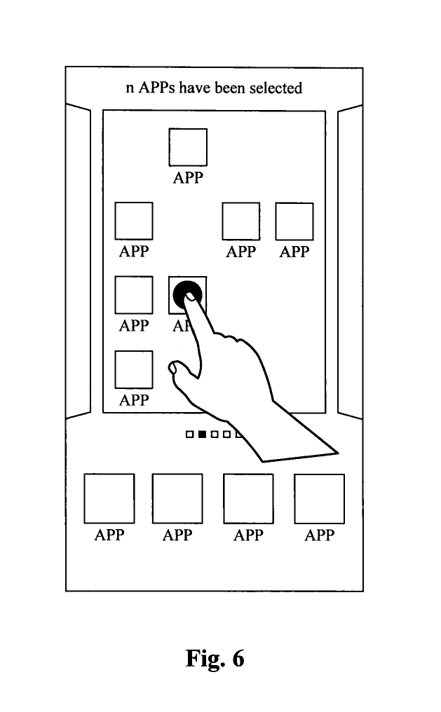

Also referring to FIG. 2, in step S203, the device continually receives the user's selection of icons, marks the selected icons as icons to be arranged, and stores the icons to be arranged in the buffer region. For example, to mark the selected icons, the device removes the selected icons from the thumbnail of the desktop, and places the selected icons as the icons to be arranged in the first predetermined area one by one, according to a sequence that the icons are selected by the user. FIG. 5 is a diagram of a display on the screen of the device after the device receives the user's selection of the icons, according to an exemplary embodiment. FIG. 6 is a diagram showing that the device receives a user selection of an icon, according to an exemplary embodiment.

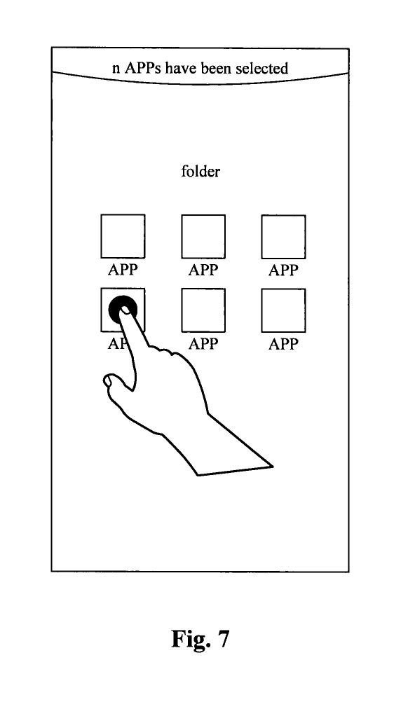

In one exemplary embodiment, an icon selected by the user is a folder icon representing a folder. Accordingly, the device displays all the icons in the folder, and marks icons in the folder that are selected by the user as icons to be arranged. In the illustrated embodiment, the device displays in the top part of the screen a number of APP icons selected by the user. FIG. 7 is a diagram showing that the user selects icons of n APPs in a folder, respectively, according to an exemplary embodiment.

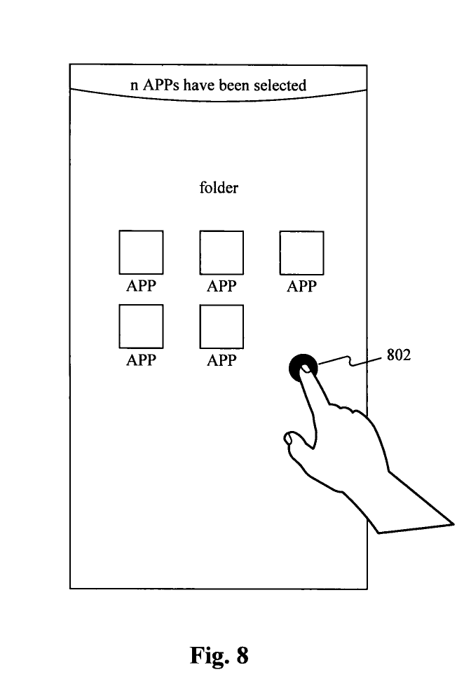

In one exemplary embodiment, after the device receives the selection of icons in the folder, the device further detects a click from the user on a blank area of the folder, i.e., a display area of the folder except the areas occupied by the APP icons and a folder title in the display area of the folder, to close the folder. FIG. 8 is a diagram showing that the device detects a click on a blank area 802 to close a folder in the batch arranging mode, according to an exemplary embodiment.

Still referring to FIG. 2, in step S204, the device performs an arranging operation on the icons to be arranged that are in the buffer region, according to an arranging instruction received from the user. For example, the device may perform the following arranging operations: moving a single icon, removing a single icon, moving a plurality of icons, removing a plurality of icons, as described below.

### (1) Moving a Single Icon

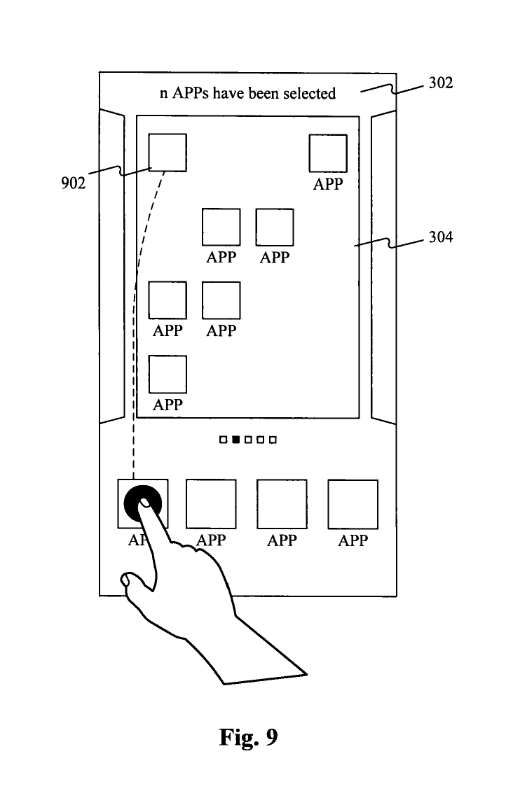

In one exemplary embodiment, if the device receives from the user a click, e.g., a single click, on an icon to be arranged that is displayed in the first predetermined area, the device places the clicked icon to be arranged as a target icon onto a first empty space on the desktop, and removes the clicked icon from the buffer region and from the first predetermined area. For example, the device displays that the clicked icon moves up to the first empty space on the desktop from the first predetermined area. FIG. 9 is a diagram showing that a single icon is moved from the first predetermined area to an empty space 902 on the desktop, according to an exemplary embodiment.

### (2) Removing a Single Icon

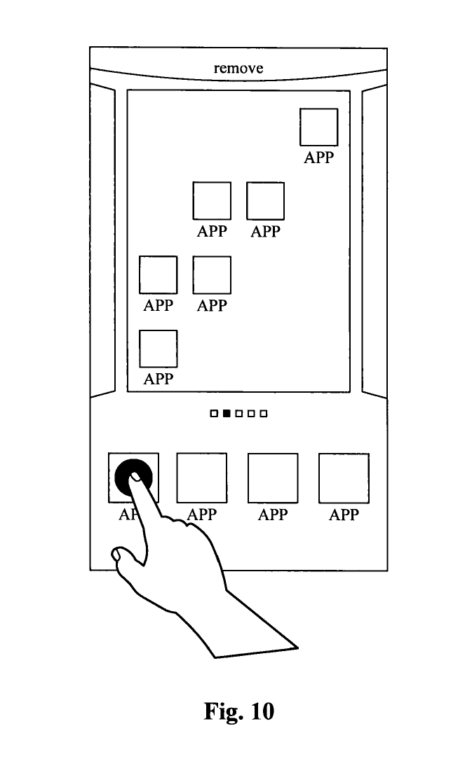

In one exemplary embodiment, if the device receives from the user a long press on an icon, e.g., a press longer than a preset time, the device sets the long-pressed icon as the target icon, and sets the second predetermined area to display the removing bar which is used to remove icons. If the device detects that the user drags the target icon to the display area of the removing bar, the device removes the target icon and uninstalls the APP corresponding to the target icon. FIG. 10 is a diagram showing that the device receives a long press on an icon to be arranged, according to an exemplary embodiment.

### (3) Moving a Plurality of Icons

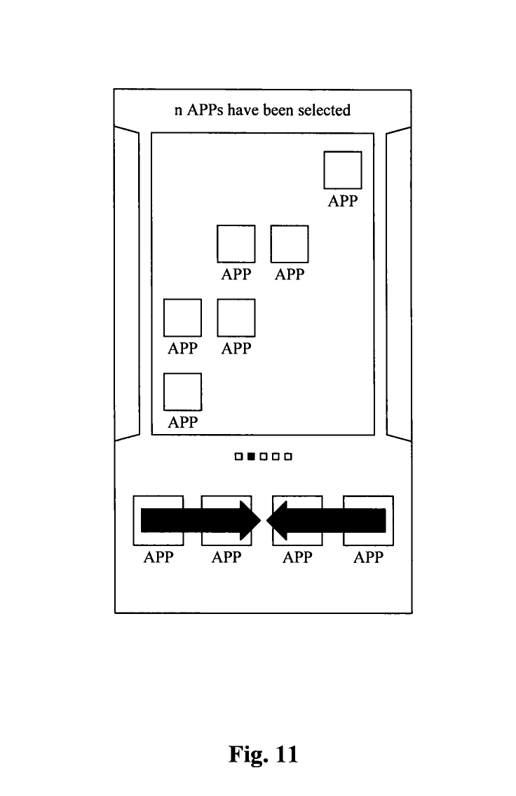

In one exemplary embodiment, the device receives from the user a selection of a plurality of icons. For example, the device detects a two-finger pinch on the icons displayed in the first predetermined area. Also for example, the device detects that the user's finger slides over the icons displayed in the first predetermined area along an edge of the screen, or detects that the device is shaken by the user, to receive the selection of the icons. FIG. 11 is a diagram showing that the device detects the two-finger pinch on the icons in the first predetermined area to select the icons to be arranged, according to an exemplary embodiment.

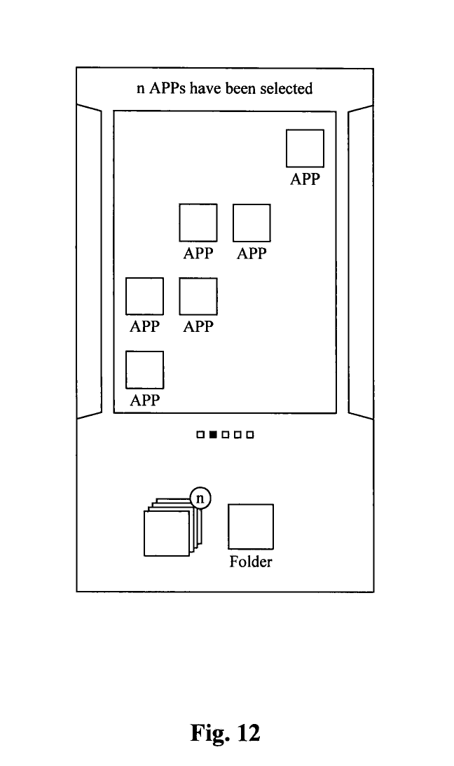

FIG. 12 is a diagram of a display on the screen of the device after the icons to be arranged are selected, according to an exemplary embodiment. Referring to FIG. 12, after the icons to be arranged are selected, the device displays the selected icons as n stacked icons, and sets the n stacked icons as target icons, where n is the number of the selected icons to be arranged.

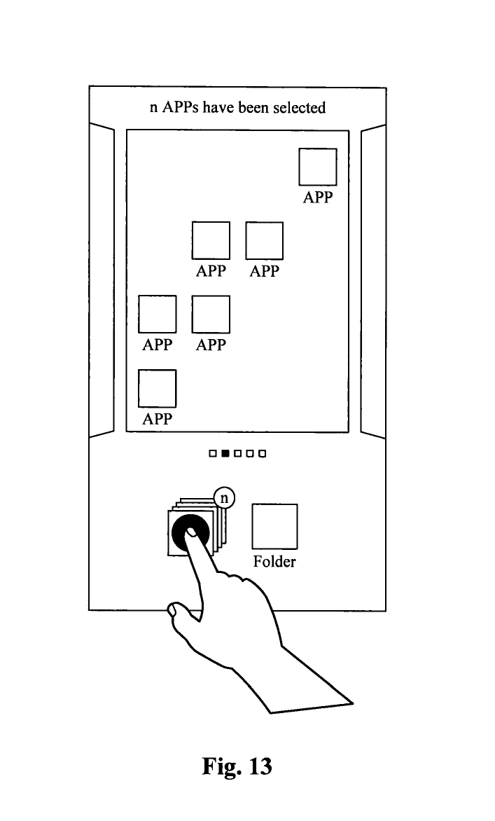

In one exemplary embodiment, the device detects a click on the target icons. Accordingly, the device places the target icons onto empty spaces on the desktop according to the sequence that the icons are selected by the user in step S203. FIG. 13 is a diagram showing that the device receives a click on the target icons to be moved, according to an exemplary embodiment.

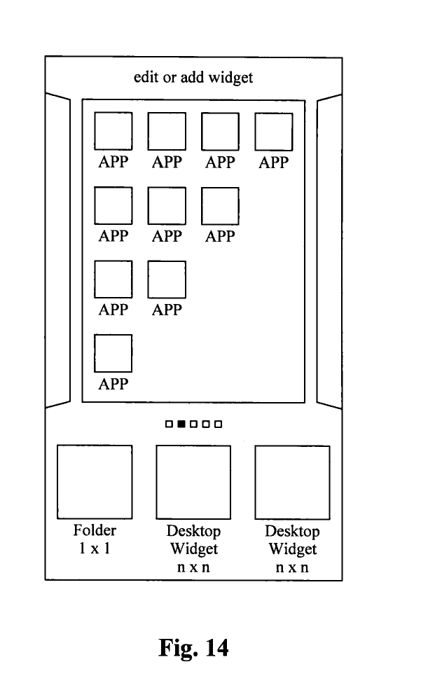

In one exemplary embodiment, the device determines whether there are sufficient empty spaces on the desktop to arrange the target icons, before placing the target icons onto the empty spaces. If it is determined that there are sufficient empty spaces, the device places the target icons onto the empty spaces, and the desktop returns to the edit mode after the placing process is completed. FIG. 14 is a diagram of a display on the screen of the device after the target icons are placed onto the empty spaces on the desktop when there are sufficient empty spaces, according to an exemplary embodiment.

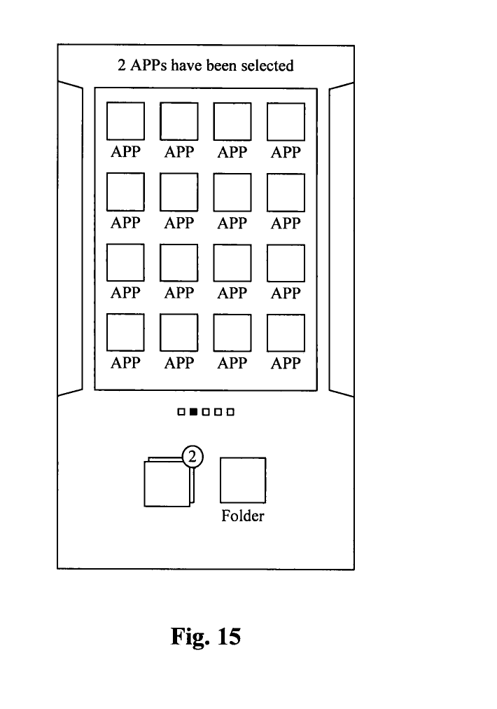

If it is determined that there are not sufficient empty spaces on the desktop, the device places the target icons according to the sequence that the icons are selected by the user. The icons which cannot be placed onto the empty spaces remain being displayed in the first predetermined area. The device also displays in the second predetermined area the number of the icons which cannot be placed onto the empty spaces. FIG. 15 is a diagram of a display on the screen of the device after the target icons are placed onto the empty spaces on the desktop when there are not sufficient empty spaces, according to an exemplary embodiment.

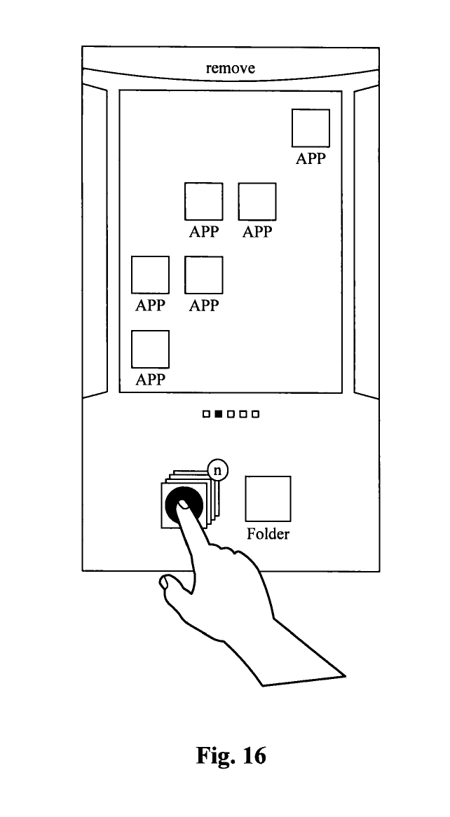

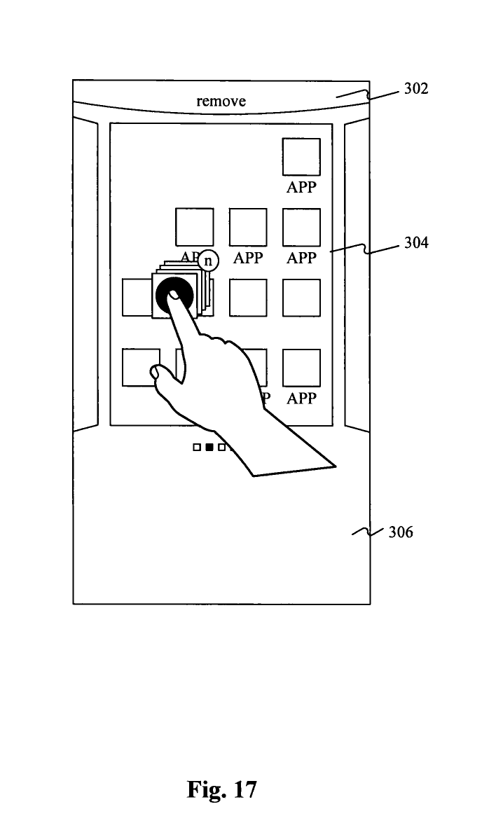

In one exemplary embodiment, the device detects a long press, e.g., a press longer than a preset time period, on the target icons, and detects that the target icons are dragged onto spaces between two icons on the desktop. Accordingly, the device places the target icons onto a location adjacent to the two icons by pushing away the two icons and inserting the target icons. FIG. 16 is a diagram showing that the device receives a long press on the target icons, according to an exemplary embodiment. FIG. 17 is a diagram showing that the device places the target icons onto a location pointed by a finger of the user through the pushing and inserting, according to an exemplary embodiment. In one exemplary embodiment, the device determines whether there are sufficient empty spaces on the desktop to place the target icons, and places the target icons based on the determination, as described above.

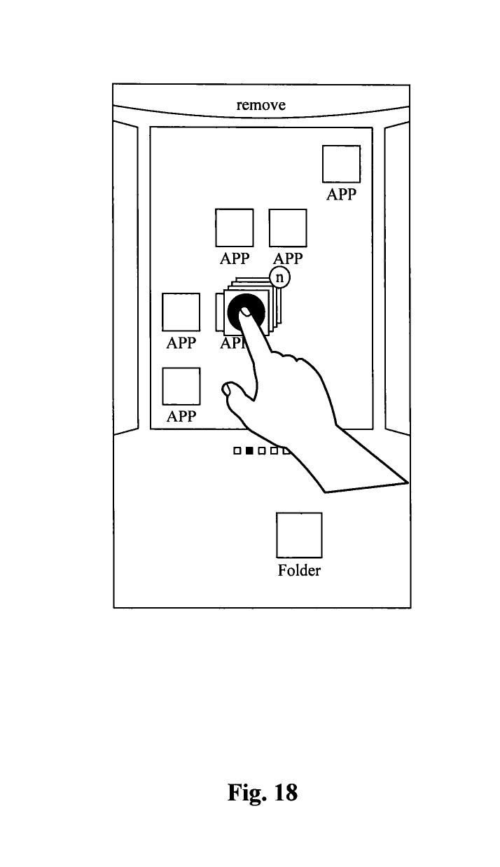

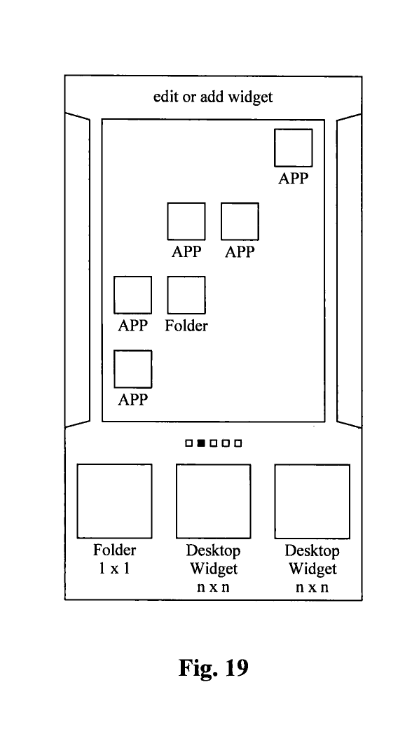

In one exemplary embodiment, the device receives a long press on the target icons and detects that the target icons are dragged to a region on the desktop that is occupied by an APP icon. Accordingly, the device generates a folder with a preset name and places the target icons and the APP icon occupying the region into the generated folder. FIG. 18 is a diagram showing the device detects that the target icons are dragged to the region on the desktop occupied by an APP icon, according to an exemplary embodiment. FIG. 19 is a diagram of a display on the screen of the device after the device places the target icons and the APP icon occupying the region into the generated folder, according to an exemplary embodiment.

### (4) Removing a Plurality of Icons

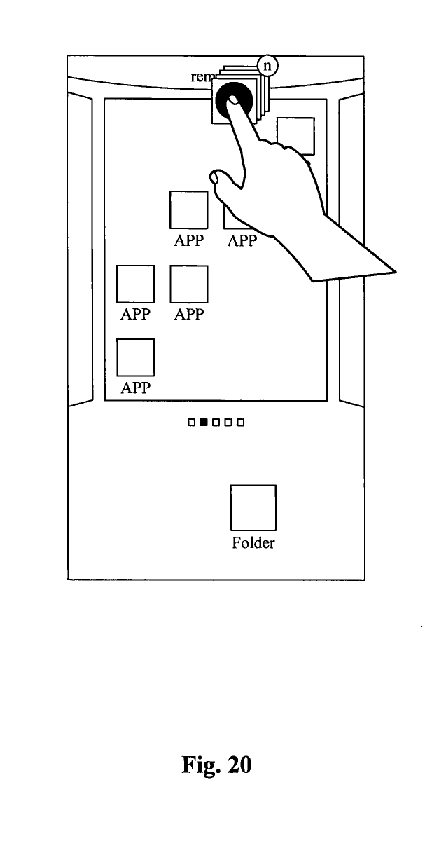

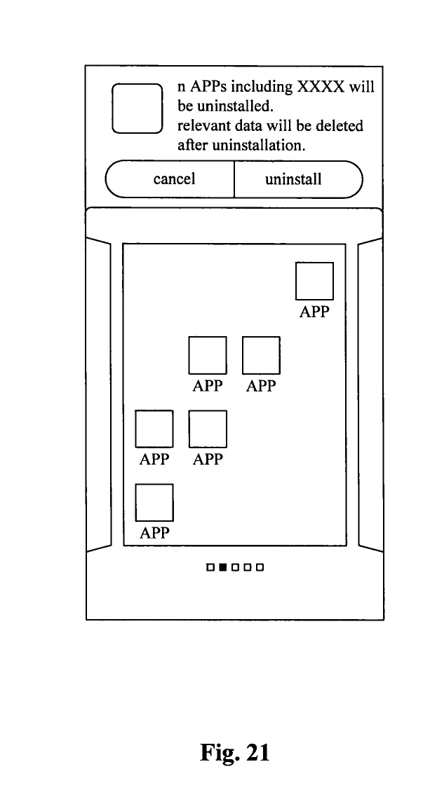

In one exemplary embodiment, the device receives a long press on the target icons. Accordingly, the device displays a removing bar at the second predetermined area, i.e., the top part of the screen. If the device further detects that the target icons are dragged to the second predetermined area, the device prompts the user to determine whether to uninstall the APPs corresponding to the target icons, respectively. FIG. 20 is a diagram showing that the device detects the target icons are dragged to the removing bar, according to an exemplary embodiment. FIG. 21 is a diagram of a display on the screen of the device that prompts the user to determine whether to uninstall the APPs corresponding to the target icons, respectively, according to an exemplary embodiment.

If the device receives an instruction from the user confirming the uninstallation, the device removes the target icons and uninstalls the APPs corresponding to the target icons, respectively. If the device receives an instruction cancelling the uninstallation, the device re-displays the target icons in the first predetermined area.

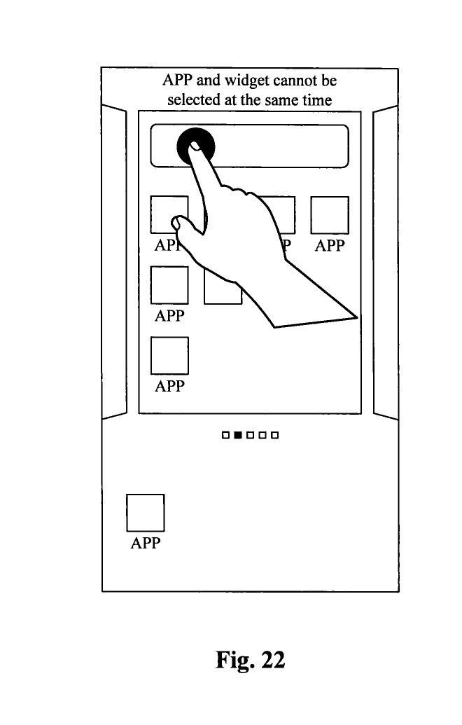

FIG. 22 is a diagram showing that the device detects a click on a widget icon in a batch arranging mode, according to an exemplary embodiment. In the illustrated embodiment, the widget icon cannot be operated in the batch arranging mode. Accordingly, the device displays a notification message to the user.

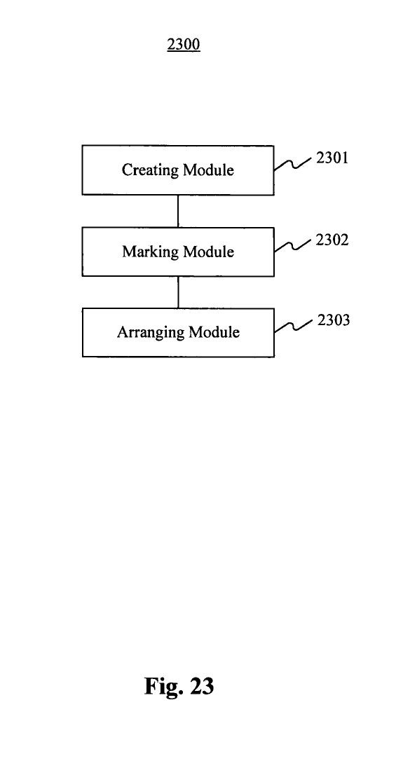

FIG. 23 is a block diagram of a device 2300 for arranging icons, according to an exemplary embodiment. For example, the device 2300 may be the device described above in connection with FIGS. 1-22. Referring to FIG. 23, the device 2300 includes a creating module 2301 configured to create a buffer region; a marking module 2302 configured to mark one or more icons selected by a user as icons to be arranged and store the icons to be arranged in the buffer region; and an arranging module 2303 configured to perform an arranging operation on the icons to be arranged in the buffer region according to an arranging instruction from the user.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

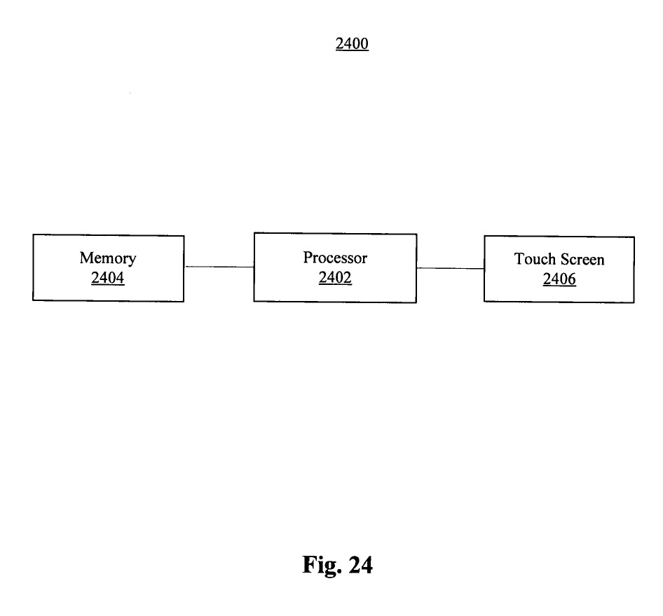

FIG. 24 illustrates a block diagram of a device 2400, according to an exemplary embodiment. For example, the device 2400 may be the device described above in connection with FIGS. 1-22. Referring to FIG. 24, the device 2400 includes a processor 2402 configured to execute program instructions to perform the above described methods for arranging icons, memory resources, represented by a memory 2404, configured to store information and program instructions, and a screen, such as a touch screen 2406, for displaying the icons.

In exemplary embodiments, there is also provided a non-transitory computer-readable storage medium including instructions, such as included in the memory 2404, executable by the processor 2402 in the device 2400, for performing the above described methods for arranging icons. For example, the non-transitory computer-readable storage medium may be a CD-ROM, a universal serial bus (USB) flash disk, or a mobile hard disk drive (HDD).

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to arrange icons displayed on a screen of the device, comprising:
creating a buffer region in a memory of the device;
marking one or more icons selected by a user as one or more icons to be arranged;
storing the icons to be arranged in the buffer region; and
performing an arranging operation on the icons to be arranged that are stored in the buffer region, according to an arranging instruction from the user.

2. The method according to claim 1, before the creating of the buffer region, further comprising:
causing a desktop to enter an edit mode based on a user operation; and
setting a first predetermined area on the screen as a selecting area for selection by the user.

3. The method according to claim 2, wherein the creating of the buffer region, the marking of the selected icons, and the storing of the icons to be arranged comprise:
detecting a click on a first icon on the desktop;
in response to the detecting, creating the buffer region and setting the first predetermined area on the screen as a display area for the icons to be arranged;
marking a plurality of icons selected by the user as the icons to be arranged; and
storing the icons to be arranged in the buffer region and displaying the icons to be arranged in the first predetermined area.

4. The method according to claim 3, further comprising:
marking the plurality of icons selected by the user as the icons to be arranged and storing the icons to be arranged in the buffer region according to a sequence that the plurality of icons are selected by the user; and
displaying the plurality of icons selected by the user in the first predetermined area according to the sequence that the plurality of icons are selected by the user.

5. The method according to claim 1, wherein a first icon selected by the user is a folder icon representing a folder, the marking further comprising:
displaying all icons in the folder; and
marking at least one icon in the folder selected by the user as an icon to be arranged.

6. The method according to claim 5, further comprising:
detecting a click on any area in a display area of the folder other than areas occupied by all the icons in the folder and a title of the folder; and
closing the folder in response to the detecting.

7. The method according to claim 3, wherein the performing of the arranging operation comprises:
detecting a click on a first one of the icons to be arranged that are displayed in the first predetermined area, and
placing, in response to the detecting, the first icon onto a first empty space on the desktop.

8. The method according to claim 3, wherein the performing of the arranging operation comprises:
detecting a press longer than a predetermined time period on a first one the icons to be arranged that are displayed in the first predetermined area;
setting the first icon as a target icon; and
setting a second predetermined area on the screen as a display area for a removing bar.

9. The method according to claim 8, further comprising at least one of:
detecting that the target icon is dragged to the second predetermined area, and removing the target icon and uninstalling an application corresponding to the target icon;
detecting that the target icon is dragged to a location on the desktop without an icon, and placing the target icon onto the location; or
detecting that the target icon is dragged to a region on the desktop occupied by an icon, and generating a folder with a preset name at the region occupied by the icon and placing the icon occupying the region and the target icon into the generated folder.

10. The method according to claim 3, wherein the performing of the arranging operation comprises:
detecting that a preset event is triggered; and
in response to the detecting, displaying a number of all the icons to be arranged that are stored in the buffer region, and setting all the icons to be arranged stored in the buffer region as target icons.

11. The method according to claim 10, further comprising at least one of detecting a click on the target icons, and placing the target icons onto empty spaces on the desktop according to a sequence that the target icons are selected;
detecting a press longer than a predetermined time on the target icons, setting a second predetermined area on the screen as a display area for a removing bar, detecting that the target icons are dragged to the second predetermined area, and removing the target icons and uninstalling respective applications corresponding to the target icons;
detecting that the target icons are dragged to a region on the desktop occupied by an icon, generating a folder with a preset name at the region occupied by the icon, and placing the icon occupying the region and the target icons into the generated folder; or
detecting that the target icons are dragged to a location on the desktop without an icon, and placing the target icons onto the location.

12. The method according to claim 11, wherein the placing of the target icons onto the empty spaces on the desktop according to the sequence that the icons are selected comprises:
determining whether there are sufficient empty spaces on the desktop;
if it is determined that there are sufficient empty spaces on the desktop, placing the target icons onto the empty spaces on the desktop according to the sequence that the icons are selected; and
if it is determined that there are not sufficient empty spaces on the desktop, determining icons to be placed according to a number of the empty spaces and the sequence that the icons are selected, and placing the determined icons onto the empty spaces on the desktop according to the sequence that the icons are selected.

13. The method according to claim 10, wherein the detecting of the preset event is triggered comprises detecting at least one of:
an event that two contacts with the screen move toward each other in the first predetermined area; or
an event that a single contact with the screen moves in one direction in the first predetermined area.

14. The method according to claims 1, further comprising:
removing the icons to be arranged from the buffer region.

15. A device, comprising:
a processor;
a memory for storing instructions executable by the processor; and
a screen;
wherein the processor is configured to:
create a buffer region in the memory;
mark one or more icons selected by a user as one or more icons to be arranged;
store the icons to be arranged in the buffer region; and
perform an arranging operation on the icons to be arranged that are stored in the buffer region, according to an arranging instruction from the user.

16. The device according to claim 15, wherein the processor is further configured to:
cause a desktop to enter an edit mode based on a user operation; and
set a first predetermined area on the screen as a selecting area for selection by the user.

17. The device according to claim 16, wherein the processor is further configured to:
detect a click on a first icon on the desktop;
in response to the detecting, create the buffer region and set the first predetermined area on the screen as a display area for the icons to be arranged;
mark a plurality of icons selected by the user as the icons to be arranged; and
store the icons to be arranged in the buffer region and display the icons to be arranged in the first predetermined area.

18. The device according to claim 17, wherein the processor is further configured to:
mark the plurality of icons selected by the user as the icons to be arranged and store the icons to be arranged in the buffer region according to a sequence that the plurality of icons are selected by the user; and
display the plurality of icons selected by the user in the first predetermined area according to the sequence that the plurality of icons are selected by the user.

19. The device according to claim 15, wherein a first icon selected by the user is a folder icon representing a folder, the processor being further configured to:
display all icons in the folder; and
mark at least one icon in the folder selected by the user as an icon to be arranged.

20. A non-transitory computer-readable medium having stored therein instructions that, when executed by a processor of a device, cause the device to perform a method for arranging icons displayed on a screen of the device, the method comprising:
creating a buffer region in a memory of the device;
marking one or more icons selected by a user as one or more icons to be arranged;
storing the icons to be arranged in the buffer region; and
performing an arranging operation on the icons to be arranged that are stored in the buffer region, according to an arranging instruction from the user.
